(19) United States
(12) Patent Application Publication
(10) Pub. No.: US 2008/0244710 A1
(43) Pub. Date: Oct. 2, 2008

(54) METHODS AND SYSTEMS FOR AUTHENTICATION USING IP MULTIMEDIA SERVICES IDENTITY MODULES

(75) Inventor: George Foti, Dollard des Ormeaux (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/692,526

(22) Filed: Mar. 28, 2007

(51) Int. Cl. H04L 9/32

(52) U.S. Cl. 726/4

(57) ABSTRACT

Systems and methods provide two levels of authentication for a user on an IMS-IPTV system. A first level of authentication validates an ISIM card (set-top box) with the network using, e.g., an IMSI comparison. A second level of authentication validates the user through comparing user entered information with information stored on the ISIM card. Additionally, methods for populating security information onto the ISIM card to facilitate the second level of authentication are described.

### TECHNICAL FIELD

The present invention relates generally to communications systems and in particular to methods and systems for authenticating devices and users.

### BACKGROUND

As the level of technology increases, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally cellular phones and Wi-Fi have added a mobile element to communications. Similarly, in the entertainment industry, 30 years ago there was only one format for television and this format was transmitted over the air and received via antennas located at homes. This has evolved into both different standards of picture quality such as, standard definition TV (SDTV), enhanced definition TV (EDTV) and high definition TV (HDTV), and more systems for delivery of these different television display formats such as cable and satellite. Additionally, services have grown to become overlapping between these two industries. As these systems continue to evolve in both industries, the service offerings will continue to merge and new services can be expected to be available for a consumer. Also these services will be based on the technical capability to process and output more information, for example as seen in the improvements in the picture quality of programs viewed on televisions, and therefore it is expected that service delivery requirements will continue to rely on more bandwidth being available throughout the network including the “last mile” to the end user.

Another related technology that impacts both the communications and entertainment industries is the Internet. The physical structure of the Internet and associated communication streams have also evolved to handle an increased flow of data. Servers have more memory than ever before, communications links exist that have a higher bandwidth than in the past, processors are faster and more capable and protocols exist to take advantage of these elements. As consumers' usage of the Internet grows, service companies have turned to the Internet (and other IP networks) as a mechanism for providing traditional services. These multimedia services can include Internet Protocol television (IPTV, referring to systems or services that deliver television programs over a network using IP data packets), video on demand (VOD), voice over IP (VoIP), and other web related services received singly or bundled together.

To accommodate the new and different ways in which IP networks are being used to provide various services, new network architectures are being developed and standardized. One such development is the Internet Protocol Multimedia Subsytem (IMS). IMS is an architectural framework which uses a plurality of Internet Protocols (IP) for delivering IP multimedia services to an end user. A goal of IMS is to assist in the delivery of these services to an end user by having a horizontal control layer which separates the service layer and the access layer. More details regarding IMS systems are provided below.

As different companies start to deliver these new services, ensuring that only authorized users have access to the system becomes important for various reasons. For example, if a company was providing a multicast of a TV program only the users that have paid for the program should have access to the program. Additionally, the end user should typically only have access to the privileges for which the user has paid. If a user has paid for a basic service, that user should not typically have access to services that are considered to be premium services. Also, for other security reasons, such as identity theft, access to IP services needs to be controlled.

One method used for security in some cell phones involves the use of a subscriber identity module (SIM). A SIM is a type of removable smart card that contains identifying information associated with a user and is used, for example, with a mobile phone in the Global System for Mobile Communications (GSM) and related systems. The term “SIM” is also sometimes used to refer to the application that operates on the removable smart card. Since the SIM card securely contains identifying information regarding a user, a SIM card can be moved from one mobile phone to another mobile phone allowing immediate access and activation to the second mobile phone for the user. These SIM cards can contain memory and an application(s) can reside within the memory which is used to authenticate and identify a subscriber. Some examples of authenticating measures/user information are the international circuit card identification (ICCID), authentication key (Ki) and the international mobile subscriber identity (IMSI). A sample authentication process for a mobile phone startup process will now be described using FIG. 1.

Initially a mobile unit, such as a cell phone containing a SIM card, is powered up in step 102. The user's IMSI is then transmitted to the mobile operator (or device/node that controls network access/authorization) at step 104. The mobile operator performs a search of the relevant database at step 106. Upon completion of a successful search, the mobile operator generates a random number, signs the random number and calculates another number at step 108. The mobile operator then transmits the random number back to the SIM attached to the mobile unit at step 110. The random number is then signed by the mobile unit and transmitted back to the mobile operator at step 112. The mobile operator then compares both signed messages at step 114 and, if these messages match, access is authorized to the network at step 118 for the requesting mobile unit, otherwise access is denied at step 116.

While SIMs have traditionally been used in the context of cellular phones, newer system architectures (such as IMS) which adopt some techniques from GSM and follow-on standards, are expected to use SIM cards (or the like) as part of their security sub-systems. However, some of the characteristics of the end users devices associated with IMS services differ from the characteristics of cell phones. For example, cell phones are typically each associated with an individual user. By way of contrast, set-top boxes associated with the provision of, for example, IPTV services will typically be associated with a number of different users, e.g., members of a family.

Accordingly exemplary embodiments described below address the need for expanding SIM security techniques to provide for multi-user environments, e.g., to control access of one user to another user's services and data associated with a single ISIM card.

### SUMMARY

According to one exemplary embodiment a system includes a memory unit, containing an Internet Protocol multimedia subscriber identity module (ISIM) application, connected to a processor; and wherein the processor runs the ISIM application contained in the memory, wherein upon running the ISIM application and receiving user input information, the ISIM application retrieves a corresponding value from a security file stored in the memory unit and compares the value with the user input.

According to another exemplary embodiment a method for authenticating a user's access to IPTV services via an ISIM application includes requesting, from the ISIM application, user authentication input, receiving, by the ISIM application, the user authentication input, comparing the user authentication input with corresponding, stored security data, and selectively granting, by the ISIM application, access to the IPTV services based on a result of the comparing step.

According to yet another exemplary embodiment a computer-readable medium contains instructions which, when executed on a computer, perform the steps of requesting, from an ISIM application, user authentication input, receiving, by the ISIM application, the user authentication input, comparing the user authentication input with corresponding, stored security data, and selectively granting, by the ISIM application, access to IPTV services based on a result of the comparing step.

### BRIEF DESCRIPTION OF THE DRAWINGS

The accompanying drawings illustrate exemplary embodiments, wherein:

FIG. 1 is a flowchart illustrating a security procedure using a SIM attached to a mobile unit;

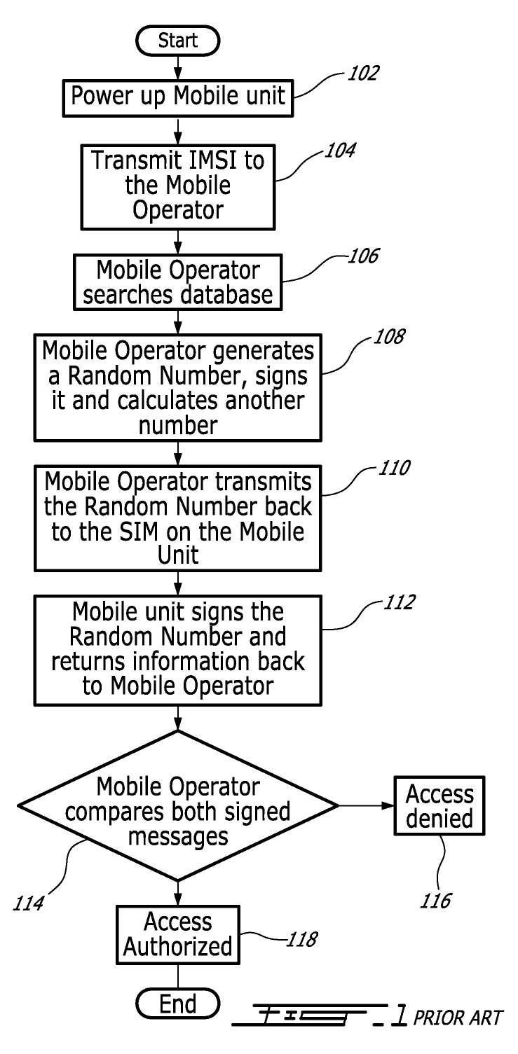

FIG. 2 depicts an IMS architecture according to exemplary embodiments;

FIG. 3 shows a grouping of networks according to an exemplary embodiment;

FIG. 4 illustrates an IPTV system according to exemplary embodiments;

FIG. 5 depicts a signaling diagram according to exemplary embodiments;

FIG. 6 depicts a signaling diagram for updating a security file according to exemplary embodiments;

FIG. 7 depicts an IP multimedia subscriber identity module (ISIM) according to exemplary embodiments; and

FIG. 8 is a flowchart illustrating a method for authenticating a user's access to IPTV services via an ISIM application according to exemplary embodiments.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

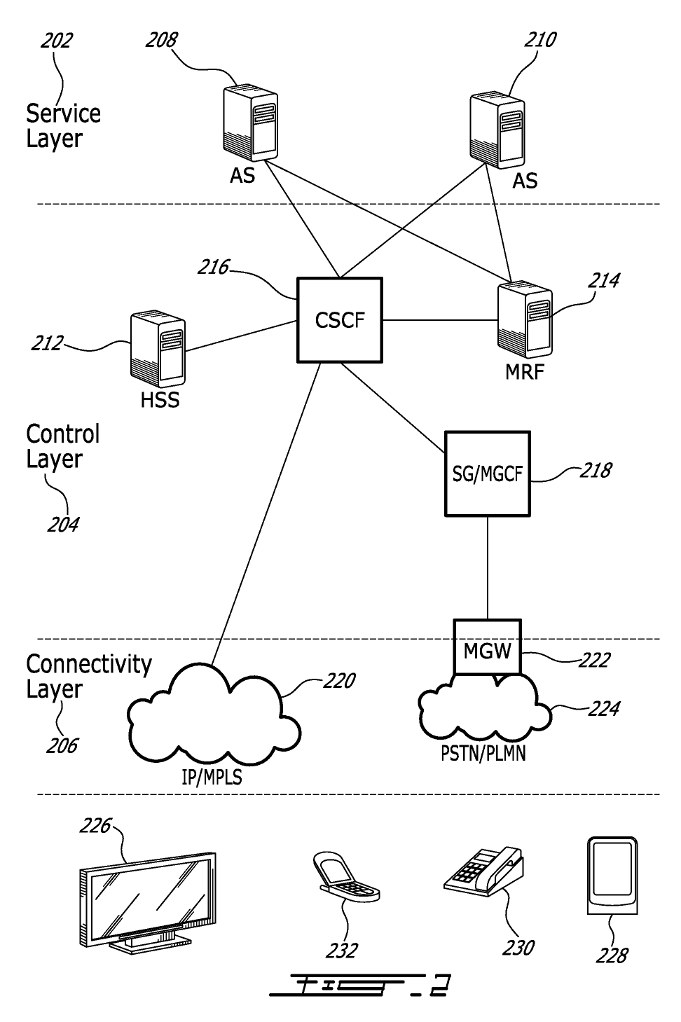

In order to provide some context for this discussion, a brief discussion of an exemplary IMS architecture in which exemplary embodiments can be implemented will now be described with respect to FIG. 2. The architecture used in IMS can be broken down into three layers: (1) a service layer 202; (2) a control layer 204; and (3) a connectivity layer 206. The service layer 202 includes application servers (ASs) 208, 210 which contain services and applications that can be delivered to an end user, e.g., Internet Protocol Television (IPTV) services. The control layer 204 contains a home subscriber server (HSS) 212, a media resource function (MRF) 214, a call service control function (CSCF) 216, a signaling gateway/media gateway control function (SG/MGCF) 218 and a media gateway 222. These elements in the control layer 204 are typically used for managing session set-up, resource modification and release of resources. The connectivity layer 206 includes routers and switches used in both the backbone network and the access network. These elements are shown in the Figure by Internet Protocol (IP)/multi-protocol label switching (MPLS) 220, the public switched telephone network (PSTN)/public land mobile network (PLMN) 224 and media gateway 222. This connectivity layer 206 is used to connect various end user devices to either each other or a variety of services and applications. Some types of end user devices are, for example, web TV 226 which is capable of displaying television signals received in an IP format, personal digital assistant (PDA) 228, telephone 230, and cell phone 232. It is to be appreciated that more or fewer elements can exist in an IMS architecture.

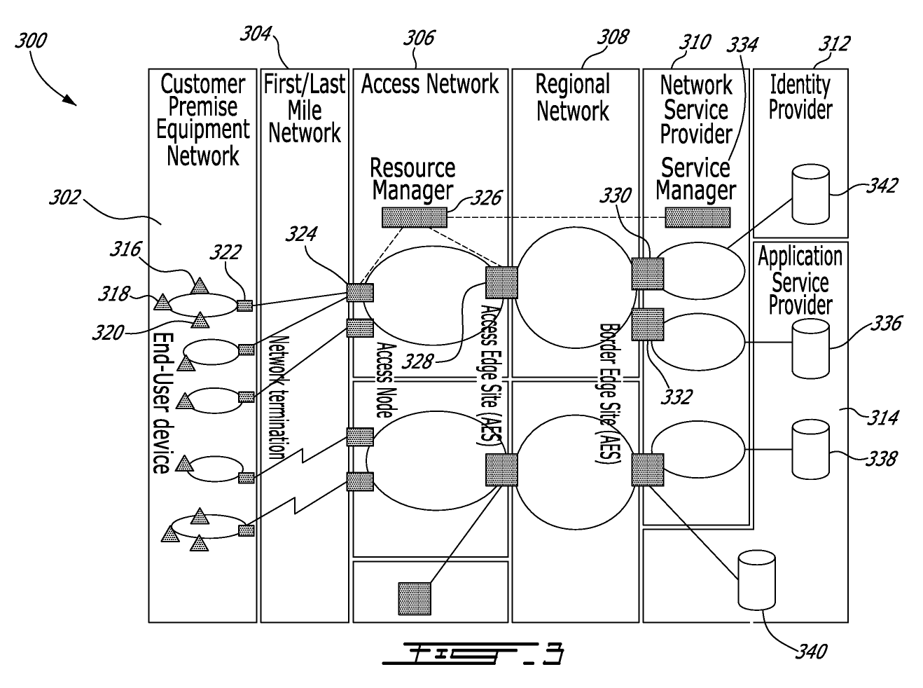

Using the previously described IMS architectures shown in FIG. 2, an end user should be able access a multitude of applications and service providers through a single access point. For example, a user may want to watch an IPTV show on one television, record a movie for future use on a recorder, and have streaming audio playing in another room all of which are provided via a single access point. To implement these requests from an end user, numerous messages and components interact. In order to provide some context for a discussion of how this process works an exemplary grouping of networks will be described with respect to FIG. 3. The grouping of interconnected networks 300 in FIG. 3, can be broken down into a customer premise equipment network 302, a first/last mile network 304, an access network 306, a regional network 308, a service provider network 310, an identity provider 312 which typically provides an authentication server that is contacted for cryptographic proof that an end user owns the submitted identifier and application service providers 314. The customer premise equipment network 302 contains networked home equipment such as a computer 316, laptop 318, TV 320 and access node or portal 322. Access node 322 could be a router or any other connection from the home to an outside network. First/last mile network 304 contains the various connections and routers used (not shown) to get from access node 322 in the customer premise network 302 to access node 324 in the access network 306. Access network 306 contains access node 324, access edge site (AES) 328 and resource manager (RM) 326 which runs on a server (not shown). AES 328 is in communication with nodes in both access network 306 and regional network 308. Regional network 308 also contains border edge sites (BES) 330, 332 which are also part of service provider network 310. Service provider network 310 also contains the service manager (SM) 334 which runs on a server (not shown). Additionally, servers 336, 338, 340 from the application service providers 314 and server 342 from the identity provider 312 are able to communicate with items within the service provider network 310. These exemplary components are used for communication, control and delivery of a service to an end user. However, it is to be understood that there can be more or fewer components used than described above, such as more service providers having more applications running on more servers and/or more routers in the communications path.

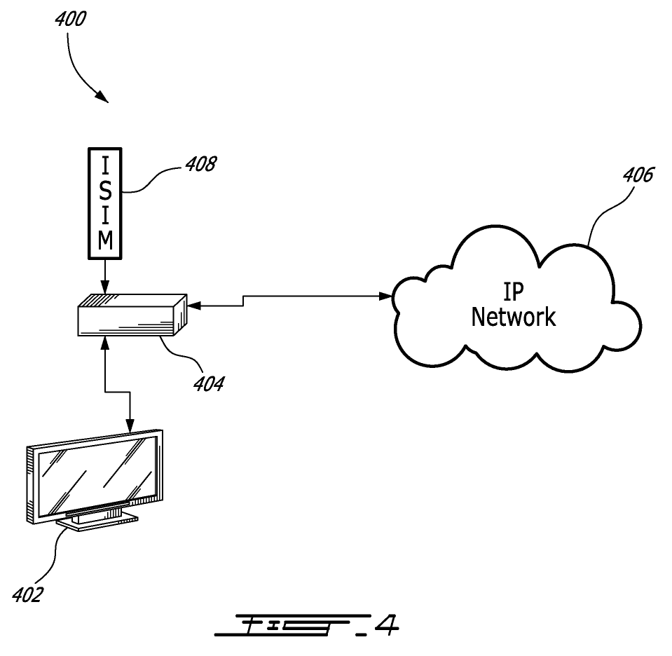

The above described components describe communication paths and resources which can be used to transmit a service or multiple services from service providers to end users. One application of particular interest for these exemplary embodiments is IPTV. An exemplary portion of an IPTV system which can typically also use the resources shown in FIGS. 2 and 3 will now be described as shown in FIG. 4. The IPTV system 400 includes a web TV 402, a set-top box 404 and a network 406. The web TV 402 is capable of displaying a variety of video signals and can be used for voice communications. Set-top box 404 typically can be used to control inputs to web TV 402 and is in communications with both web TV 402 and network 406. Additionally, set-top box 404 can contain a removable smart card 408 such as an IP multimedia services identity module (ISIM) application on a universally integrated circuit card (UICC). The UICC contains memory within which security information and applications can be stored. The UICC is also sometimes referred to herein as an ISIM card. Network 406 contains the elements such as routers, nodes, etc. (not shown) used to connect the end user to desired services and contains the ability to communicate with set-top box 404 for authentication/authorization purposes. Additionally in this example, set-top box 404 acts as a communications node for accessing a network 406. Alternatively, a separate device such as a modem or a router could be used to connect the set-top box 404 and web TV 402 to the network 406 and that network 406 could be as simple as local area network or as complex as the Internet connected to multiple private networks.

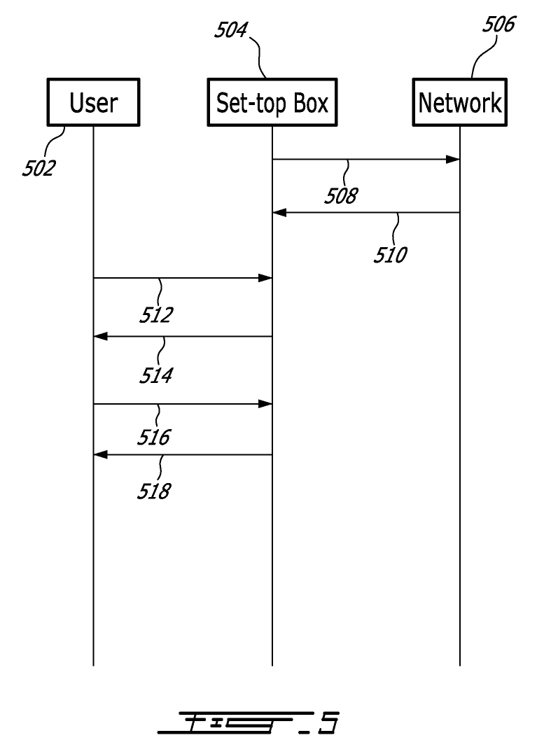

As described in the Background, security for an IPTV system (or any system using IMS) is important for managing access to a network. An exemplary messaging method according to an exemplary embodiment for providing access and authorization in a system using IMS and IPTV, such as described above with respect to FIGS. 2-4, will now be described using the signaling diagram of FIG. 5. According to this exemplary method, two levels of authentication occur prior to allowing a user access to his or her desired IPTV application(s). The first level of authentication occurs between a set-top box 504 and a network 506. Set-top box 504 typically includes a removable UICC which can contain, among other information, a security file, an international mobile subscriber identity (IMSI) and an ISIM application. Initially, e.g., upon powering up of the set-top box 504, a message 508 is transmitted from set-top box 504 to a network 506. This message 508 includes the IMSI (or other identifying information) which the network 506 uses to verify that the device associated with this IMSI is authorized access to the network 506. Upon a successful validation of the IMSI by network 506, a message 510 is sent from network 506 to set-top box 504 informing set-top box 504 that access to the network 506 has been authorized.

As discussed above, since web TV 402 could be accessed by different users, each of whom have different profiles and, potentially, restrictions on their usage of IPTV services, these exemplary embodiments also provide for a second level of authentication associated with ISIM 408 to, among other things, prevent identity theft. The second level of authentication is an interaction between a user 502 and the set-top box 504. The user 502 begins his or her session with a message or command 512 to set-top box 504 describing which service is desired, e.g., via a remote control device. Upon receipt of a service request message 512, set-top box 504 transmits a message 514 back to the user prompting the user to enter security information, such as a user name and password. This security information is transmitted in message 516 back to the set-top box 504 where an application running on the UICC matches the entered security information to information stored on a security file on the UICC. Since these exemplary embodiments are specifically intended to enable controlled access of multiple users to a system via a single ISIM application/card, it will be appreciated that the security file can store identification information associated with multiple, different users. Upon a successful match the user is notified in message 518 that his or her applications are available for use. While the exemplary embodiment shown in FIG. 5 has used IPTV as the desired application, other applications that use the IMS architecture or other similar architectures can also use this authorization method. Also while the set-top box has been shown as an independent unit, it could be part of another device, such as, a television. Moreover, other devices can be used in addition to or as an alternative to the above described user message exchanges, such as using a keyboard or a mobile phone.

One additional benefit from this two level authentication system is that a user can take the ISIM card 408 and use it with other devices that can both accept the ISIM and are IMS-IPTV capable, while at the same time safeguarding other users' services which may be accessible through the same ISIM card. For example, suppose that a user has subscribed to a bundled IPTV package for their household. The user then goes on a business trip and stays at a hotel that has IPTV-IMS connectivity to a television with an associated set-top box in each room. The user can insert their ISIM card into the set-top box, and upon the security access check access their own personal services, such as having their phone services routed to this IPTV capable terminal. However, other users associated with the same ISIM card 408 will have their services and profiles protected by the second (user) level of authentication.

As described in the above exemplary embodiment, for the second level of authentication, user 502 entered security information is matched to previously stored information in a security file stored in the memory on the UICC. However, when a UICC is used for the first time, the security file stored in the onboard memory device is typically empty. In this case, upon power up, the system can use a default internet multimedia public user identity (IMPU) for the security interaction with the ISIM 408 which allows the security file to be updated from the service provider as described in the following exemplary embodiments.

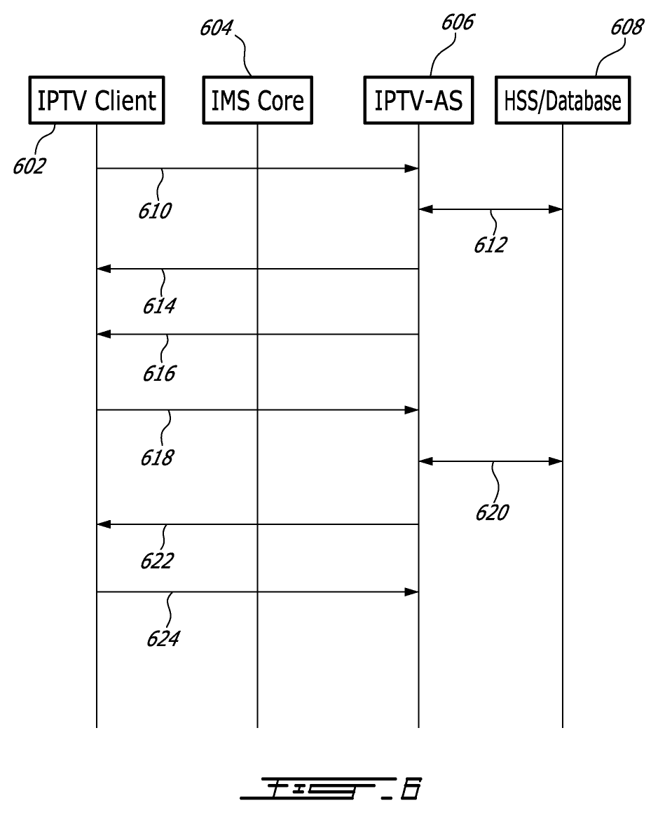

According to one exemplary embodiment, the security file associated with the ISIM can be initially populated by the IMS-IPTV network controller after the initial IPTV terminal function (ITF) (or set-top box) power up sequence is completed. At this point, as shown in FIG. 6, the IPTV client 602 transmits a message 610 to an IPTV application server (IPTV-AS) 606 subscribing to a new event for updating the security file associated with the ISIM. The IPTV-AS 606 has two-way communications 612 with a HSS (or an equivalent server/database combination) 608 wherein information is exchanged and updated regarding a user's subscription and profile. The IPTV-AS 606 then transmits an acknowledgement (a 200 OK message) 614 to the IPTV client 602. This is followed by a notification message 616 which is sent from the IPTV-AS 606 to the IPTV client 602. IPTV client 602 responds to the IPTV-AS 606 with a 200 OK message 618. At this point the security file receives an initial update based upon the contents of notification message 616. Also the IPTV-AS 606 and the HSS 608 are again in communications 620 exchanging information regarding the end user(s), and appropriate changes are saved by the HSS 608. Such appropriate changes could include changes to passwords and/or changes to the IMPU(s).

Upon completion of the message exchange between the IPTV-AS 606 and the HSS 608, another notification message 622 is transmitted from the IPTV-AS 606 to the IPTV client 602. This could be due to changes in the security information (e.g. password change, new identities and passwords included, etc.). The IPTV client 602 acknowledges this notification message 622 in a follow-on transmission 624 to the IPTV-AS 604. Additionally, the security file is again updated as required based upon the contents of the notification message 622. Security is ensured in this system because the device has been previously authorized access to the network via the above described authentication process.

According to another exemplary embodiment, a security file associated with an ISIM can be initially populated by the IPTV client 602 retrieving the remotely located security file using a web protocol, such as hyper text transfer protocol (HTTP), from a communications node (or equivalent). Generic bootstrapping architecture (GBA) is used to ensure security for this process. Upon receipt of the security file by the IPTV client 602, the security file associated with the ISIM is updated or created. Additionally, the frequency for accessing the remote security can either be predetermined or alternatively, a subscribe/notify procedure (as described above) could be used to inform the IPTV client 602 of a change in the security file at the remotely located communications node. Upon such notification, the IPTV client 602 could automatically retrieve the updates to the security file from the remotely located communications node.

According to yet another exemplary embodiment, the security file associated with the ISIM can be initially populated by the end user. An IMS-IPTV application provided to the user, on the ISIM for example, can include the tools typically used to allow the user to create and manage the security file. For example, after the completion of the power up sequence, an application on the ISIM could prompt the user to enter login and password information. Additionally, accounts for other household members that could use this ISIM can also be setup at this time, or at a later time.

According to exemplary embodiments, when the second level of user authentication fails, the device that is trying to use IPTV or IMS related services can power on but will typically have reduced capabilities. For example, suppose that a user is powering up a set-top box in communication with a TV that is both Internet and voice capable. In this example, the first level of security is authorized which allows the set-top box to access a network, but the second level fails because the user is not an authorized user (e.g., does not have a login ID or associated password). In this case, the user may, according to this exemplary embodiment, use the basic functions of the device, i.e., watch regular TV channels, but the user may not access other features associated with the device, i.e., no access to incoming phone calls via the TV or other services related to a unique user. These basic functions of the device are allowable assuming that the first layer of authentication, i.e., the device is allowed access to the network, has succeeded.

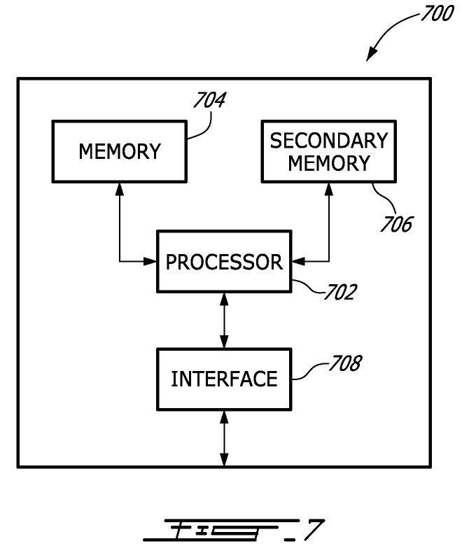

The exemplary embodiments described above provide for messages and protocols involving ISIM cards and nodes which include such cards. An exemplary ISIM card 700 will now be described with respect to FIG. 7. ISIM card 700 can contain a processor 702 (or multiple processor cores), memory 704, one or more secondary memory devices 706 and an interface unit 708, e.g., to facilitate communications between ISIM card 700 and the rest of the network, as well as user interface(s) and other applications residing on the same device as the ISIM card. The memory can be used for storage of exemplary items described above such as IMPUs, password and login information or any other desirable information. Thus, an ISIM card according to an exemplary embodiment may include a processor for transmitting and receiving messages associated with at least one of end user information related to an IMS-IPTV network and/or security information.

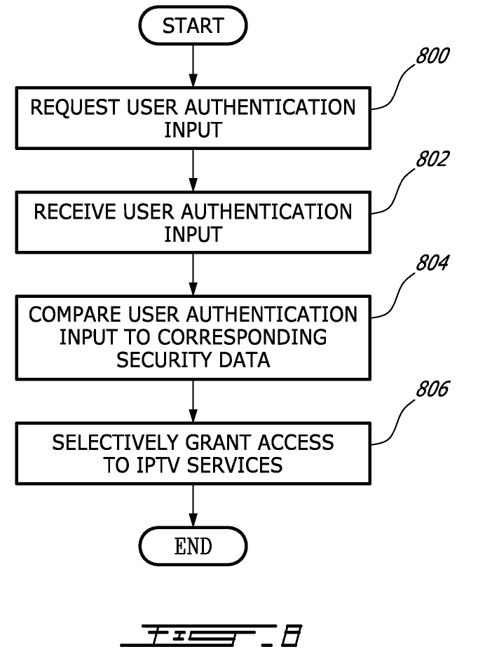

Thus it will be appreciated based upon the foregoing that, according to an exemplary embodiment, a method for authenticating a user's access to IPTV services via an ISIM application can include the steps illustrated in the flowchart of FIG. 8. Therein, user authentication input is requested by an ISIM application at step 800. After receiving the user authentication input (step 802), e.g., a user ID and password, that user authentication input is compared with corresponding, stored security data, e.g., from a security file stored on an ISIM card, at step 804. Access to the requested IPTV services are selectively granted by the ISIM application based on a result of said comparing step at step 806.

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

The above-described exemplary embodiments are intended to be illustrative in all respects, rather than restrictive, of the present invention. Thus the present invention is capable of many variations in detailed implementation that can be derived from the description contained herein by a person skilled in the art, such as using a card reader in place of a set-top box that has an input slot for a card. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A system comprising:
a memory unit, containing an Internet Protocol multimedia subscriber identity module (ISIM) application, connected to a processor; and
said processor for running said ISIM application contained in said memory, wherein upon running said ISIM application and receiving user input information, said ISIM application retrieves a corresponding value from a security file stored in said memory unit and compares said value with said user input.

2. The system of claim 1, wherein said system is a set-top box.

3. The system of claim 2, wherein said set-top box contains a removable card containing said memory and said processor.

4. The system of claim 1, wherein said system is a smart card.

5. The system of claim 1, wherein said processor communicates with a network for determining access to said network prior to receiving said user input.

6. The system of claim 5, wherein said access determination is performed by said network by matching a received international mobile subscriber identity (IMSI) from said ISIM application to a pre-stored list of allowable IMSIs.

7. The system of claim 1, wherein said security file is initially empty.

8. The system of claim 7, wherein said security file is populated manually.

9. The system of claim 7, wherein said security file is populated by a received message from a network node.

10. The system of claim 7, wherein said security file is populated by said processor requesting said security file from a network node.

11. A method for authenticating a user's access to IPTV services via an ISIM application comprising:
requesting, from said ISIM application, user authentication input;
receiving, by said ISIM application, said user authentication input;
comparing said user authentication input with corresponding, stored security data; and
selectively granting, by said ISIM application, access to said IPTV services based on a result of said comparing step.

12. The method of claim 11, further comprising:
transmitting, from said ISIM application to a network, an international mobile subscriber identity (IMSI); and
receiving, by said ISIM application, authorization to access said network.

13. The method of claim 11, wherein said security file is initially empty.

14. The method of claim 13, further comprising:
populating said security file with said corresponding, stored security data which is manually entered by a user.

15. The method of claim 13, further comprising:
populating said security file with said corresponding, stored security data which is from a received message from a network node.

16. The method of claim 13, further comprising:
populating said security file with said corresponding, stored security data by requesting said security file from a network node.

17. A computer-readable medium containing instructions which, when executed on a computer, perform the steps of:
requesting, from an ISIM application, user authentication input;
receiving, by said ISIM application, said user authentication input;
comparing said user authentication input with corresponding, stored security data; and
selectively granting, by said ISIM application, access to IPTV services based on a result of said comparing step.

18. The computer-readable medium of claim 17, further comprising:
transmitting, from said ISIM application to a network, an international mobile subscriber identity (IMSI); and
receiving, by said ISIM application, authorization to access said network.

19. The computer-readable medium of claim 17, wherein said security file is initially empty.

20. The computer-readable medium of claim 19, further comprising:
populating said security file with said corresponding, stored security data which is manually entered by a user.

21. The computer-readable medium of claim 19, further comprising:
populating said security file with said corresponding, stored security data which is from a received message from a network node.

22. The computer-readable medium of claim 19, further comprising:
populating said security file with said corresponding, stored security data by requesting said security file from a network node.
